(19) United States
(12) Patent Application Publication
(10) Pub. No.: US 2009/0268023 A1
(43) Pub. Date: Oct. 29, 2009

(54) SURVEILLANCE CAMERA DEVICE WITH A LIGHT SOURCE

(76) Inventor: Wen-Hsiung Hsieh, Keelung (TW)

Correspondence Address: Wen-Hsiung Hsieh, 2F, No. 59, Lane 421, MaiJin Road, Anle District, Keelung, 204, TW

(21) Appl. No.: 12/110,324

(22) Filed: Apr. 27, 2008

(51) Int. Cl. H04N 7/18

(52) U.S. Cl. 348/143; 348/370; 348/E07.085

(57) ABSTRACT

A surveillance camera device with a light source is composed of a camera, a control unit which is connected to the camera, a light-source control unit which is connected to the control unit, and a light source. The control unit directly gets the illumination of images captured by the camera or its related parameters, to determine whether illumination of the environment of image captured is sufficient. When the illumination of the environment of image captured is changed, the control unit will send lighting control signal to the light-source control unit to activate or deactivate the light source, or adjust the light output intensity of the light source automatically, such that the illumination of the environment of the images captured can be accurately determined to provide the correct light fill-in for shooting clear images.

### BACKGROUND OF THE INVENTION

a) Field of the Invention

The present invention relates to a surveillance camera device with a light source, and more particularly to a surveillance camera device which is provided with a function of automatic light fill-in.

b) Description of the Prior Art

An ordinary surveillance camera will usually activate a night-vision function to fill in infrared light automatically when illumination of external environment is insufficient, so as to capture clear images under a condition that illumination is not sufficient; whereas, a common night-vision camera is an infrared camera.

A conventional infrared camera includes a circuit board, a center of which is provided with a lens containing an image sensor, with a periphery of the lens being surrounded by a plurality of infrared light emitting diodes, and near the lens being provided with a light-sensing element. When capturing images, illumination of external environment is detected by the light-sensing element that is located in the camera and aligns with a direction in taking images by the lens, and a signal of the illumination of ambient environment is processed by a circuit of the circuit board to further control whether the infrared light emitting diodes are activated or not.

The conventional light-sensing element used for the infrared camera is a photoresistor or photodiode or phototransistor which can only detect visible light. Therefore, when the light of the external environment is insufficient and thus the infrared light emitting diodes is activated to illuminate, as the infrared light is invisible light, it cannot be detected by this kind of light-sensing element. Accordingly, the light-sensing element will be able to accurately detect the visible light intensity of the external environment and not affected by the infrared light illuminated. However, if white-light light emitting diodes are used instead of infrared light emitting diodes, when the light-sensing element has detected that the visible light intensity of the external environment is insufficient; the white-light light emitting diodes will be activated to fill in the light. As white light is visible light, it can be detected by the light-sensing element. Therefore, the light-sensing element detects that the external environment has the sufficient visible light intensity, to deactivate the white-light light emitting diodes, thereby easily resulting in incorrect determination. As the white-light light emitting diodes are deactivated, the light-sensing element detects that the visible light of the external environment is insufficient again, to activate the white-light light emitting diodes once more. Accordingly, the white-light light emitting diodes are activated and deactivated repeatedly, allowing the light intensity of the external environment unable to be determined accurately to control whether the light is filled in correctly, thereby prohibiting the camera from capturing clear images.

In addition, the surveillance camera using light-sensing element is easy to misjudge because the light-sensing element can detect only the ambient illumination near the light-sensing element itself, therefore, the camera itself, but not directly detect the illumination of the environment of images captured by the camera. When there is some distance between the camera and the space of its images captured, the difference of the ambient illumination between the environment near the camera and the environment of the images captured will cause the misjudgment. Therefore, it will easily result in the incorrect determination when the conventional structure is applied to the infrared camera or the white-light camera, thereby affecting a quality of capturing images and thus truly requiring improvement.

### SUMMARY OF THE INVENTION

The primary object of the present invention is to provide a surveillance camera device with a light source, which can determine illumination of the environment of images captured by the camera to correctly control light fill-in, such that the camera can capture clear images when the illumination of the environment of images captured is changed.

Accordingly, the present invention includes primarily a camera, a control unit which is connected to the camera, a light-source control unit which is connected to the control unit, and a light source. The camera includes an image sensor to capture images, and an image processing unit to get and process image signals, that can provide parameters such as illumination of images captured or its related parameters such as AGC (Automatic Gain Control) or AEC (Automatic Exposure Control) values. The control unit gets parameter values, such as the illumination of images from the camera or its related parameters such as AGC (Automatic Gain Control) or AEC (Automatic Exposure Control) values, from the image processing unit; and outputs a lighting control signal to allow the light-source control unit to activate or deactivate the light source or to adjust the light output intensity of the light source, such that the camera can capture clear images, when the control unit has determined that the illumination of the environment of images captured is changed. By using the control unit to directly get the illumination of the images detected by the camera or its related parameters, the illumination of the environment of images can be accurately determined to correctly control whether the light fill-in is needed, and the intensity of the fill-in light, thereby preventing from resulting in the incorrect determination, and allowing the clear images to be shot successfully.

Accordingly, the present invention can accurately determine the illumination of the environment of images captured to decide whether the light output intensity of the light source or the light source should be activated, thereby being able to be applied to the camera device which uses the white-light light emitting diodes or the infrared light emitting diodes as the light source, to save the photoresistor or other light-sensing element used by the conventional camera.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of a preferred embodiment of the present invention.

### DETAILED DESCRIPTION OF THE PREFERRED EMBODIMENTS

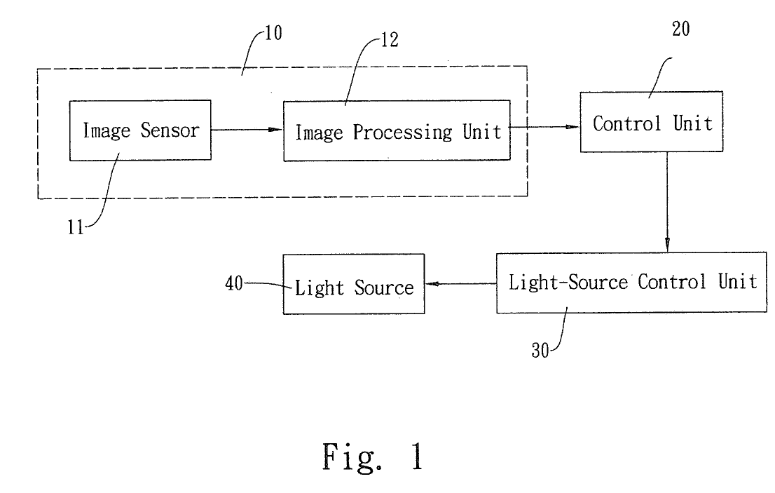

Referring to FIG. 1, it shows a preferred embodiment of the present invention which comprises primarily a camera 10, a control unit 20 which is connected to the camera 10, a light-source control unit 30 which is connected to the control unit 20, and a light source 40. The camera 10 includes an image sensor 11 and an image processing unit 12 which is connected to the image sensor 11.

The image sensor 11 can be a CCD (Charge-Coupled Device) or a CMOS (Complementary Metal-Oxide Semiconductor), to capture external images and to transmit image signals to the image processing unit 12.

The image processing unit 12 is an integrated circuit which operates arithmetic and logic processing or digital signal processing or both, which can be a MCU (Microcontroller Unit), a DSP (Digital Signal Processor), a FPGA (Field-Programmable Gate Array), or a CPLD (Complex Programmable Logic Device). The image processing unit 12 gets and processes the image signals; as well as outputs parameters, such as illumination of the images captured or its related parameters such as AGC (Automatic Gain Control) or AEC (Automatic Exposure Control) values, to the control unit 20.

The control unit 20 is connected to the image processing unit 12 of the camera 10, to get control reference values from the image processing unit 12, such as the illumination of the images captured or its related parameters such as AGC (Automatic Gain Control) or AEC (Automatic Exposure Control) values. When the control unit 20 has determined that the illumination of the images captured is changed, a lighting control signal will be outputted to the light-source control unit 30 which will activate or deactivate the light source, or adjust the light output intensity of the light source 40, depending on the lighting control signal.

The control unit 20 is an integrated circuit which operates arithmetic and logic processing or digital signal processing, which can be an MCU (Microcontroller Unit), a DSP (Digital Signal Processor), an FPGA (Field-Programmable Gate Array), or a CPLD (Complex Programmable Logic Device) which outputs a corresponding lighting control signal in responding to the change of the illumination of the images captured or its related parameters such as AGC (Automatic Gain Control) or AEC (Automatic Exposure Control) values, to control the activation or deactivation of the light source, or the light output intensity of the light source, for providing the correct light fill-in. The lighting control signal can be an electric PWM (Pulse Width Modulation) signal, or an electric analog signal or a set of parallel or serial electric digital signals.

The control unit 20 can be installed inside or outside the camera 10. Furthermore, the image sensor 11 and the image processing unit 12 can be configured into a sole integrated circuit. The image processing unit 12 and the control unit 20 can be configured into a sole integrated circuit. The image sensor 11 and the image processing unit 12 and the control unit 20 can be configured into a sole integrated circuit, also.

The light-source control unit 30 is an electronic circuit that applies power from a source of electric power to the light source 40, and maintains the light output intensity of the light source 40 based on the lighting control signal from the control unit 20.

The light source 40 is a plurality of white-light light emitting diodes or a plurality of infrared light emitting diodes.

As the present invention uses the image sensor and image processing unit to get the parameters, such as the illumination of images captured or its related parameters such as AGC (Automatic Gain Control) or AEC (Automatic Exposure Control) values; and then uses the control unit to directly access the illumination of the images captured or its related parameters to determine the light output intensity of the light source. Therefore, the illumination of the environment of images captured can be accurately determined to provide the correct fill-in light, allowing the camera to automatically choose whether the light fill-in is needed or the light output intensity of the light source needs to be adjusted, to shoot the clear images, under the condition that the illumination of the environment of images captured is changed.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A surveillance camera device with a light source, comprising:
a camera, which includes an image sensor and an image processing unit being connected to the image sensor, for capturing and processing images;
a control unit, which is connected to the camera;
a light-source control unit, which is connected to the control unit; and
a light source, which is connected to the light-source control unit;
the control unit getting the illumination of the images captured by the camera or its related parameters, and then outputting a control signal to the light-source control unit to control whether to activate the light source or to adjust the light output intensity of the light source, enabling the clear images to be captured when the illumination of the environment of the images captured by the camera is changed.

2. The camera device according to claim 1, wherein the control unit is connected to the image processing unit to get the illumination of the images captured by the camera or its related parameters.

3. The camera device according to claim 1, wherein the control unit is installed inside or outside the camera.

4. The camera according to claim 1, wherein the image sensor is a CCD image sensor.

5. The camera according to claim 1, wherein the image sensor is a CMOS image sensor.

6. The camera according to claim 1, wherein the image processing unit is an integrated circuit which operates arithmetic and logic processing or digital signal processing or both.

7. The camera according to claim 1, wherein the control unit is an integrated circuit which operates arithmetic and logic processing or digital signal processing or both.

8. The camera device according to claim 1, wherein the image processing unit and the image sensor is configured into a sole integrated circuit.

9. The camera device according to claim 1, wherein the control unit, the image processing unit is configured into a sole integrated circuit.

10. The camera device according to claim 1, wherein the control unit, the image processing unit and the image sensor is configured into a sole integrated circuit.

11. The camera device according to claim 1, wherein the light-source control unit is an electronic circuit that applies power from a source of electric power to the light source, and maintains the light output intensity of the light source or turns on and off the light source based on the lighting control signal from the control unit.

12. The camera device according to claim 1, wherein the light source is a plurality of white-light light emitting diodes.

13. The camera device according to claim 1, wherein the light source is a plurality of infrared light emitting diodes.

14. The camera device according to claim 1, wherein the control signal outputted by the control unit is a lighting control signal, to control the light output intensity of the light source or to turn on and off the light source, in responding to the illumination of the environment of images captured.

15. The camera device according to claim 14, wherein the lighting control signal is an electric pulse width modulation signal.

16. The camera device according to claim 14, wherein the lighting control signal is an electric analog signal.

17. The camera device according to claim 14, wherein the lighting control signal is a set of parallel or serial electric digital signals.
